(19) United States
(12) Patent Application Publication
(10) Pub. No.: US 2006/0066903 A1
(43) Pub. Date: Mar. 30, 2006

(54) Image file recording system and method of controlling same

(75) Inventor: Yoshiko Shiimori, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/231,891

(22) Filed: Sep. 22, 2005

(30) Foreign Application Priority Data
Sep. 24, 2004 (JP) 2004-276886

(51) Int. Cl. G06K 15/00

(52) U.S. Cl. 358/1.16

(57) ABSTRACT

Image files are prevented from being stored in duplicate. To achieve this, it is determined whether the date of creation, creation time, file size and shooting date and time, etc., of an image file that has been recorded in a digital still camera connected to an image file recording system are the same those of an image file that has already been recorded in the image file recording system. If all are identical, then the items of image data contained in the two image files are compared in terms of their binary data. If the two items of data are identical, then the image file that has been stored in the digital still camera is not recorded in the image file recording system by reason of the fact that an image file identical with this image file has already been stored in the system.

### BACKGROUND OF THE INVENTION

1. Field of the Invention

This invention relates to an image file recording system and to a method of controlling this system.

2. Description of the Related Art

There are greater opportunities for taking photographs owing to the widespread use of digital still cameras and mobile telephones equipped with a camera. Since photographs can be taken so easily, there has been an enormous increase in the number of image frames obtained through such photography. The files of the images obtained are recorded on recording media such as a memory card and images of a very large number of frames are recorded on these recording media.

In order to organize these images, the management of image files, which have been recorded on recording media, on a media-by-media basis has been considered (see the specification of Japanese Patent Application Laid-Open No. 2001-144921).

Nevertheless, there is still room for improvement.

### SUMMARY OF THE INVENTION

Accordingly, an object of the present invention is to so arrange it that images can be organized and recorded.

According to a first aspect of the present invention, the foregoing object is attained by providing an image file recording system comprising: an image file recording device for recording image files; an image file input device for inputting an image file applied thereto; a determination device for determining whether an image file that has been input from the image file input device has not yet been recorded in the image file recording device; and a recording control device for controlling the image file recording device, in response to a determination by the determination device that the image file has not yet been recorded, in such a manner that the image file that has been input from the image file input device will be recorded in the image file recording device.

The first aspect of the present invention also provides a control method suited to the image file recording system described above. Specifically, the first aspect of the present invention provides a method of controlling an image file recording system having an image file recording device for recording image files, the method comprising the steps of: inputting an applied image file; determining whether an image file that has been input has not yet been recorded in the image file recording device; and controlling the image file recording device, in response to a determination that the image file has not yet been recorded, in such a manner that the image file that has been input will be recorded in the image file recording device.

In accordance with the first aspect of the present invention, an image file is input, whereupon it is determined whether the input image file has not yet been recorded in an image file recording device. If it is determined that the image file has not been recorded, then the input image file is recorded in the image file recording device. Since an image file that has not been recorded in the image file recording device is recorded-in the image file recording device, the recording of image files in duplicate can be prevented. Since the recording of image files in duplicate can be prevented, image files can be organized and recorded.

The determination device makes the determination based upon at least one among creation date and time of an image file, size of an image file, shooting date and time of an image represented by an image file and degree of one-to-one correspondence between image data contained in an image file that has been input to the image file input device and image data contained in an image file that has been recorded in the image file recording device.

Further, the determination device may include a first determination device for determining whether an image file that has been input to the image file input device has not been recorded in the image file recording device, based upon at least one among creation date and time of an image file, size of an image file and shooting date and time of an image represented by an image file; and a second determination device, responsive to a determination by the first determination device that the image file has not been recorded, for determining, based upon the degree of one-to-one correspondence, whether the image file that has been input to the image file input device has not been recorded in the image file recording device.

First, based upon at least one among creation date and time of an image file, size of an image file and shooting date and time of an image represented by an image file, it is determined whether an image file that has been input to the image file input device has not been recorded in the image file recording device. In response to a determination that the image file has not been recorded, it is then determined, based upon the degree of one-to-one correspondence, whether the input image file has not been recorded in the image file recording device. As a result, there is a reduction in the number of times the determination is made as to whether an input image file has not been recorded in the image file recording device based upon the degree of one-to-one correspondence. Although the processing for determining the degree of one-to-one correspondence takes a comparatively long time, it need not be executed with regard to all input image files. This means that determination processing can be completed in a comparatively short time.

According to a second aspect of the present invention, the foregoing object is attained by providing an image file recording system comprising: an image file input device for inputting an image file applied thereto from a first image file recording device; a detecting device for detecting at least one of identification data specific to the first image file recording device and model data representing a model; and a second image file recording device for recording image files, which have been input from the image file input device, group by group, wherein the group is based upon the data detected by the detecting device.

The second aspect of the present invention also provides a control method suited to the image file recording system described above. Specifically, the second aspect of the present invention provides a method of controlling an image file recording system comprising the steps of: inputting an image file supplied from a first image file recording device; detecting at least one of identification data specific to the first image file recording device and model data representing a model; and recording input image files group by group, wherein the group is based upon the detected data.

In accordance with the second aspect of the present invention, at least one of identification data specific to an image file recording device that applies an image and model data representing a model is detected. Image files that have been input are recorded group by group, wherein the group is based upon the detected data.

Thus, image files can be recorded in the image file recording system upon being organized according to the image file recording device (first image file recording device) that applies the image file.

According to a third aspect of the present invention, the foregoing object is attained by providing an image file recording system comprising: a reading device for reading an image file that has been recorded on a recording medium removably loaded in the image file recording system; a detecting device for detecting identification data specific to the recording medium; and an image file recording device for recording image files, that have been read by the reading device, group by group, wherein the group is based upon the identification data detected by the detecting device.

The third aspect of the present invention also provides a control method suited to the image file recording system described above. Specifically, the third aspect of the present invention provides a method of controlling an image file recording system comprising the steps of: reading an image file that has been recorded on a recording medium removably loaded in the image file recording system; detecting identification data specific to the recording medium; and recording read image files group by group, wherein the group is based upon the detected identification data.

In accordance with the third aspect of the present invention, identification data specific to the recording medium is detected. Image files that have been read are recorded group by group, wherein the group is based upon the detected identification data.

Thus, image files can be organized and recorded on a per-recording-medium basis. The identification data is specific to the recording medium. Consequently, even if recording media are of the same type, their identification data will differ. This means that image files can be recorded upon being grouped according to a specific recording medium rather than according to the type of recording medium.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical structure of an image file recording system;

FIG. 2 illustrates an example of a directory structure;

FIGS. 3 to 5 are flowcharts illustrating processing executed by the image file recording system;

FIG. 6 illustrates an example of the file structure of a retrieved image file;

FIG. 7 illustrates an example of a device information database according to another embodiment of the present invention;

FIG. 8 illustrates an example of a directory structure according to this embodiment; and

FIG. 9 is a flowchart illustrating processing executed by the image file recording system according to this embodiment.

### DESCRIPTION OF THE PREFERRED EMBODIMENTS

A preferred embodiment of the present invention will now be described in detail with reference to the drawings.

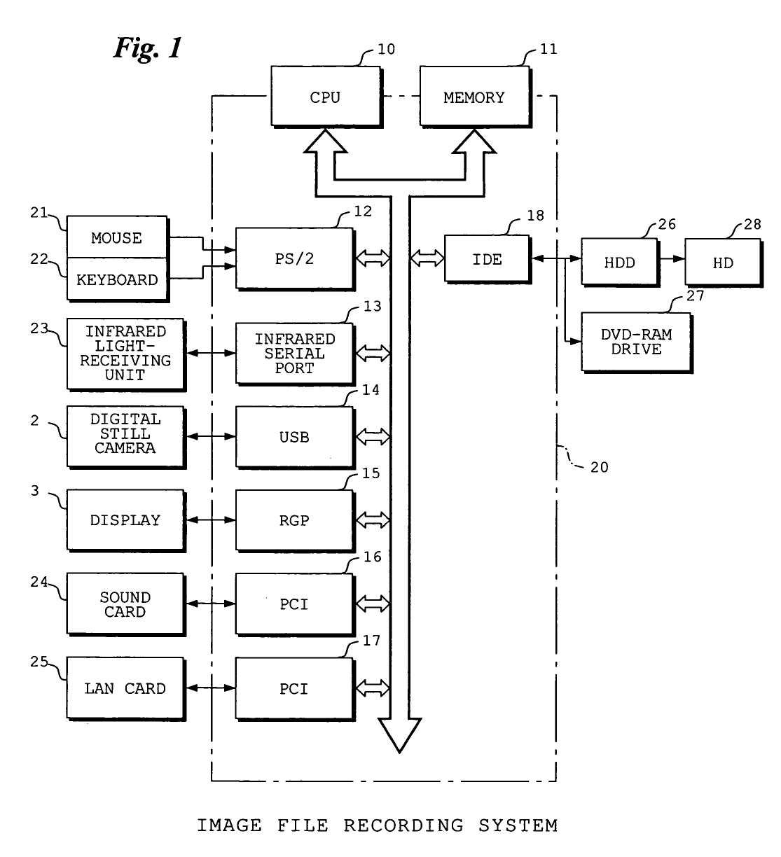

FIG. 1 illustrates the electrical structure of an image file recording system 1 according to an embodiment of the present invention.

The image file recording system 1 includes a mother board 20. The operation of the system is controlled by a CPU 10 mounted on the mother board 20.

A memory 11 that stores data temporarily is connected to the CPU 10 via a bus. Also connected to the CPU 10 via buses are a PS/2 port for connecting a mouse 21 and keyboard 22, an infrared serial port 13, a USB (Universal Serial Bus) port 14, an RGP port 15, PCI (Peripheral Component Interconnect) ports 16 and 17, and an IDE (Integrated Drive Electronics) port 18.

An infrared light-receiving unit 23 for receiving commands and the like, which are transmitted by an infrared beam from a mobile telephone 4, is connected to the infrared serial port 13. A digital still camera 2 is connected to the USB port 14. A display unit 3 is connected to the RGB port 15. A sound card 24 is connected to one PCI port 16 and a LAN (Local Area Network) card 25 is connected to the other PCI port 17. The image file recording system 1 can be connected to the Internet using the LAN card 25.

A hard-disk drive 26 for accessing a hard disk 28 on which image files and the like have been recorded and a DVD-RAM drive 27 for accessing a DVD-RAM (Digital Versatile Disc-Random-Access Memory) are connected to the IDE port 18.

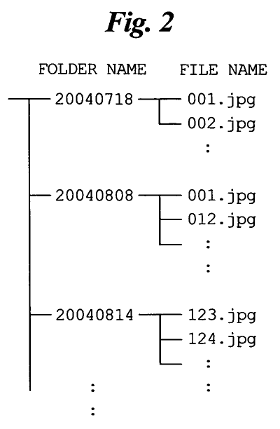

FIG. 2 illustrates an example of the directory structure of the image file recording system 1.

In the image file recording system 1 according to this embodiment, a folder having its creation date as its name contains image files created on this creation date. For example, image files having file names such as “001.jpg” and “002.jpg” have been stored in a folder having “20040718” as its file name. These image files are image files all created on Jul. 18, 2004. Image files have been stored in other folders in similar fashion.

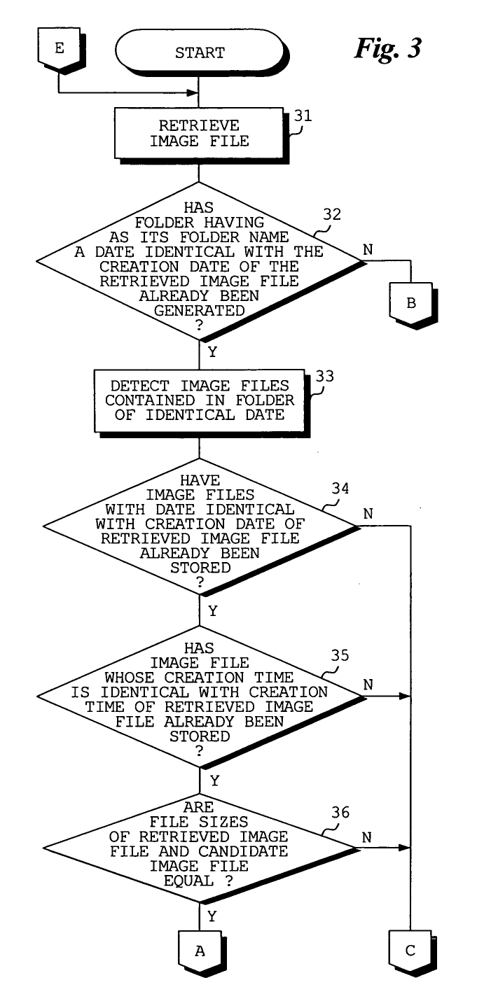

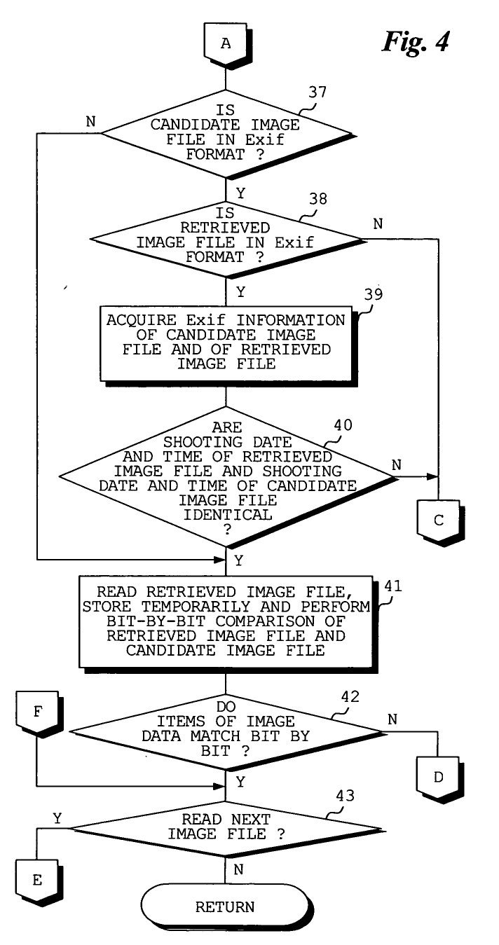

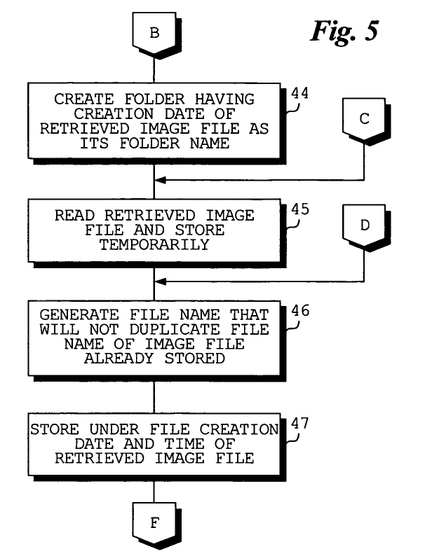

FIGS. 3 to 6 are flowcharts illustrating processing executed by the image file recording system 1.

In the processing that follows, those image files to be supplied to a image file recording system 1 that have not yet been recorded are recorded in the image file recording system 1. Further, although it is assumed that the image files are supplied from a digital still camera connected to the image file recording system 1, it goes without saying that they may be supplied from another device.

When the digital still camera is connected to the image file recording system 1, one image file to be recorded from the digital still camera to the image file recording system 1 is retrieved by searching the digital still camera (step 31).

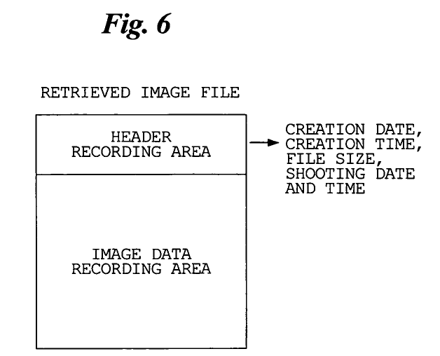

FIG. 6 illustrates an example of the file structure (data structure) of an image file that has been retrieved by a search.

The retrieved image file includes a header recording area and an image data recording area. Image data representing an image has been recorded in the image data recording area. Recorded in the header recording area are the creation date, creation time and file size of the retrieved image file as well as management information of the image data, which has been recorded in the image data recording area, such as the shooting date and time of the image that has been recorded in the image data recording area.

With reference again to FIG. 3, data representing the creation date of the retrieved image file found from the digital still camera is read. Whether a folder having as its folder name a date identical with the creation date represented by the read data has already been generated is checked (step 32).

If the folder has already been created (“YES” at step 32), the image files contained in the folder having as its folder name the date identical with the creation date of the retrieved image file are detected from the image file recording system 1 (step 33). Among the detected image files, a check is performed to determine whether there are image files having a creation date identical with the creation date of the retrieved image file about to be recorded from the digital still camera to the image file recording system 1 (step 34). If an image file having the identical creation date has already been stored in the image file recording system 1 (“YES” at step 34), then there is a possibility that the retrieved image file about to be recorded in the image file recording system 1 has already been stored in the image file recording system 1. Further confirmation, therefore, is carried out.

Next, it is determined whether an image file having a creation time identical with the creation time of the retrieved image file exists among the image files that have been stored in the image file recording system 1 and, moreover, among image files that are contained in the folder of the identical date and that have the same date of creation (step 35). If an image file also having the same creation time (this file shall be referred to as a “candidate image file”) has been stored in the image file recording system 1 (“YES” at step 35), then it is determined whether the file size of the retrieved image file and the file size of the candidate image file are equal (step 36). If the file sizes are equal (“YES” at step 36), the possibility that the retrieved image file and the candidate image file are identical becomes even greater.

Furthermore, it is determined whether both the candidate image file and retrieved image file have the Exif (Exchangeable Image File) format (steps 37, 38). If both have the Exif format (“YES” at steps 37 and 38), then whether the candidate image file and retrieved image file are identical can be checked using the shooting date and time. To accomplish this, the Exif information of the candidate image file and the Exif information of the retrieved image file is acquired (step 39). Whether the shooting date and time of the retrieved image file and the shooting date and time of the candidate image file are identical is checked using the information of the shooting date and time contained in the Exif information (step 40).

If the two shooting dates and times are identical (“YES” at step 40), there is a very great possibility that the retrieved image file and candidate image file are identical. In order to verify whether the retrieved image file and candidate image file are entirely identical, the retrieved image file is read from the digital still camera and is recorded temporarily in the image file recording system 1, and then it is determined whether the items of image data contained in respective ones of the image files match binary bit by binary bit (step 41). If the items of image data match on this binary-data basis (“YES” at step 42), this means that an image file (the candidate image file) identical with the retrieved image file has already been stored in the image file recording system 1. In order to prevent a duplicate image file from being stored in the image file recording system 1, processing for storing the retrieved image file in the image file recording system 1 is not executed and an image file to be stored in the image file recording system 1 next is searched for in the image file recording system 1 (step 43).

Whether the two items of image data match bit by bit is not checked from the start. Rather, the items of image data are checked in this fashion after it is determined whether there is a match between their file creation dates, creation times, file sizes and shooting dates and times, etc. As a result, the number of image files that undergo a check between items of image data is reduced. This means that it is possible to verify, comparatively quickly and accurately, whether an image file about to be recorded in the image file recording system 1 has already been recorded in the image file recording system 1.

If the creation dates of the image files do not match (“NO” at step 34), the creation times do not match (“NO” at step 35), the file sizes do not match (“NO” at step 36), the retrieved image file does not have the Exif format (“NO” at step 38) or the shooting dates and times do not match (“NO” at step 40), then the retrieved image file is read from the digital still camera and is stored temporarily in the image file recording system 1 (step 45).

A file name is generated for the file name of the temporarily stored retrieved image file in such a manner that it will not duplicate one inside a folder in which it is to be stored (a folder corresponding to the creation date of the retrieved image file) (step 46). The retrieved image file is saved in the image file recording system 1 under the non-duplicating file name with the creation date of the retrieved image file maintained as is (step 47).

If the image data does not match on the binary-data basis even though the file creation dates, etc., match (“NO” at step 42), this means that the retrieved image file and candidate image file do not match and therefore the candidate image file is stored in the image file recording system 1 without duplication of file names (steps 46, 47).

If a folder having as its folder name a date identical with the creation date of the retrieved image file has not been generated in the image file recording system 1 (“NO” at step 32), then a folder having the creation date of this retrieved image file as its folder name is created (step 44) and is stored in the image file recording system 1 (steps 45 to 47).

Thus, an image-file not already stored can be stored in the image file recording system 1.

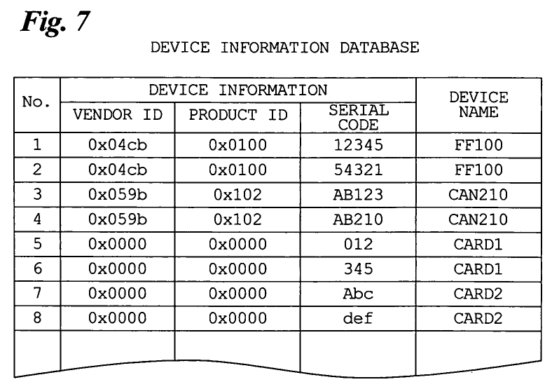

FIGS. 7 to 9 illustrate another embodiment of the present invention.

In this embodiment, image files are stored upon being grouped according to the device that applies the image files to the image file recording system 1. Further, even if a device is of the same model, image files from this device are stored as belonging to a different group if the device is different. To accomplish this, this embodiment is such that a folder name that is a model name and a folder name that is serial number are defined. A model-name folder is generated in correspondence with the model name (or name of a recording medium) of the device connected to the image file recording system 1. Image files supplied from the device are stored (grouped) inside the model-name folder in a folder corresponding to the device name and serial number of the device connected to the image file recording system 1 in which the serial-number folder of this model is generated.

FIG. 7 illustrates an example of a device information database stored in the image file recording system 1.

The device information database is for determining whether a device-name folder and a serial-number folder that correspond to a device that has been connected to the image file recording system 1 have already been generated.

The device information database contains, in correspondence with identification numbers, a vendor ID specific to the company that manufactured the device (or recording medium), a product ID (model data) specific to the model of the device, a serial code (identification data) specific to the device (the vendor ID, product ID and serial code shall be referred to as “device information”), and the device name.

By connecting a device having a vendor ID and product ID not contained in the device information database to the image file recording system, the device name and device information will be stored in the database.

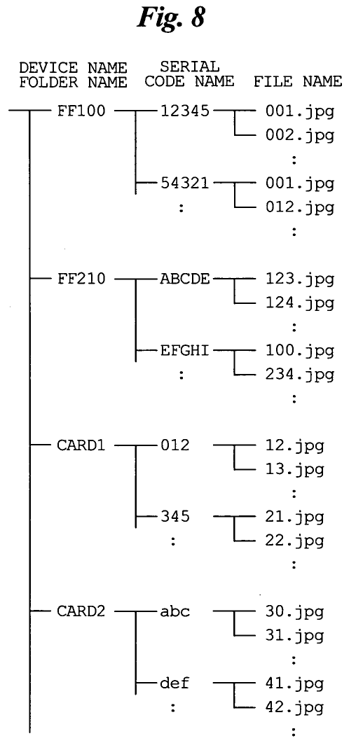

FIG. 8 illustrates an example of a directory of the image file recording system 1 according to this embodiment.

As mentioned above, a device-name folder has been generated for every device name. Serial-code folders having as their folder names the serial codes of each individual device name have been generated hierarchically under the device-name folders. Image files supplied from the devices having these serial codes have been stored hierarchically under the serial-code folders. Thus, image files have been stored upon being grouped according to the device names and serial codes of the devices that supply the image files.

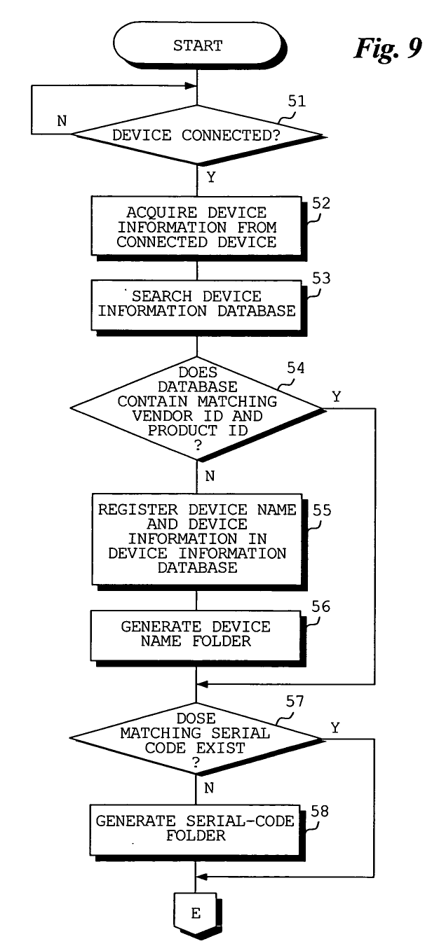

FIG. 9 is a flowchart illustrating processing executed by the image file recording system 1 in this embodiment.

When it is detected that a device of some kind has been connected to the image file recording system 1 (“YES” at step 51), device information is acquired from the connected device (step 52). When this occurs, the device information database that has been stored in the image file recording system 1 is searched (step 53) and it is determined whether the device information database contains a vendor ID and project ID that match the vendor ID and product ID contained in the device information acquired from the connected device (step 54).

If there is no match (“NO” at step 54), the device name and device information are registered in the device information database (step 55). Further, this means that a device-name folder corresponding to the device connected to the image file recording system 1 has not been generated. Accordingly, a device-name folder is generated (step 56).

Furthermore, if there is no matching serial code (“NO” at step 57), then a serial-code folder is generated hierarchically under the corresponding device-name folder (step 58).

When device-name folders and serial-code folders, etc., have thus been generated, image files that have been stored in the image file recording system 1 are placed in the corresponding folders. Thus, image files can be stored upon being grouped on a per-device basis.

In the above-described embodiment, serial-code folders are generated and, even if a device is of the same model, images files from this device are stored in different serial-code folders. However, image files may be grouped for every device-name folder without generating serial-code folders.

In the above-described embodiment, serial-code folders and device-name folders are generated using device information of devices connected to the image file recording system 1, and image files that have been stored in the devices are placed in the corresponding folders. However, it may be so arranged that serial-code folders and device-name folders are generated using information concerning a recording media, such as memory cards, and image files that have been recorded on the recording media may be stored in corresponding folders.

As many apparently widely different embodiments of the present invention can be made without departing from the spirit and scope thereof, it is to be understood that the invention is not limited to the specific embodiments thereof except as defined in the appended claims.

What is claimed is:

1. An image file recording system comprising:
an image file recording device for recording image files;
an image file input device for inputting an image file applied thereto;
a determination device for determining whether an image file that has been input from said image file input device has not yet been recorded in said image file recording device; and
a recording control device for controlling said image file recording device, in response to a determination by said determination device that the image file has not yet been recorded, in such a manner that the image file that has been input from said image file input device will be recorded in said image file recording device.

2. The system according to claim 1, wherein said determination device makes the determination based upon at least one among creation date and time of an image file, size of an image file, shooting date and time of an image represented by an image file and degree of one-to-one correspondence between image data contained in an image file that has been input to said image file input device and image data contained in an image file that has been recorded in said image file recording device.

3. The system according to claim 1, wherein said determination device includes:
a first determination device for determining whether an image file that has been input to said image file input device has not been recorded in said image file recording device, based upon at least one among creation date and time of an image file, size of an image file and shooting date and time of an image represented by an image file; and
a second determination device, responsive to a determination by said first determination device that the image file has not been recorded, for determining, based upon the degree of one-to-one correspondence, whether the image file that has been input to said image file input device has not been recorded in said image file recording device.

4. An image file recording system comprising:
an image file input device for inputting an image file applied thereto from a first image file recording device;
a detecting device for detecting at least one of identification data specific to the first image file recording device and model data representing a model; and
a second image file recording device for recording image files, which have been input from said image file input device, group by group, wherein the group is based upon the data detected by said detecting device.

5. An image file recording system comprising:
a reading device for reading an image file that has been recorded on a recording medium removably loaded in the image file recording system;
a detecting device for detecting identification data specific to the recording medium; and
an image file recording device for recording image files, that have been read by said reading device, group by group, wherein the group is based upon the identification data detected by said detecting device.

6. A method of controlling an image file recording system having an image file recording device for recording image files, the method comprising the steps of:
inputting an applied image file;
determining whether an image file that has been input has not yet been recorded in the image file recording device; and
controlling the image file recording device, in response to a determination that the image file has not yet been recorded, in such a manner that the image file that has been input will be recorded.

7. A method of controlling an image file recording system, comprising the steps of:
inputting an image file supplied from a first image file recording device;
detecting at least one of identification data specific to the first image file recording device and model data representing a model; and
recording input image files group by group, wherein the group is based upon the detected data.

8. A method of controlling an image file recording system, comprising the steps of:
reading an image file that has been recorded on a recording medium removably loaded in the image file recording system;
detecting identification data specific to the recording medium; and
recording read image files group by group, wherein the group is based upon the detected identification data.
